(19) United States
(12) Patent Application Publication
(10) Pub. No.: US 2014/0019891 A1
(43) Pub. Date: Jan. 16, 2014

(54) SYSTEM AND METHOD FOR CREATING AND DELIVERING PLATFORM INDEPENDENT INTERACTIVE APPLICATIONS ON USER DEVICES

(71) Applicant: Kallol Borah, Bangalore (IN)

(72) Inventor: Kallol Borah, Bangalore (IN)

(73) Assignee: Lukup Media PVT Ltd, Bangalore (IN)

(21) Appl. No.: 14/008,017

(22) PCT Filed: Mar. 30, 2012
(86) PCT No.: PCT/IN12/00224

§ 371 Date: Sep. 27, 2013

(30) Foreign Application Priority Data
Mar. 31, 2011 (IN) 1095/CHE/2011

(51) Int. Cl. G06F 3/048

(52) U.S. Cl. CPC G06F 3/048
USPC 715/762

(57) ABSTRACT

The various embodiments herein provide a system and method for developing and delivering a platform independent application for a plurality of user devices. The system comprises an application development framework to generate a plurality of platform independent data formats describing the application elements and actions allowed on them, a content generating server to generate a plurality of device specific data formats, a content distribution server to create a schedule for delivering the plurality of device specific data formats to the plurality of user devices and a device specific application container to render the application on the user device based on the plurality of device specific data formats received from the content distribution server. The content generating server includes a data format builder module which takes input from the application development framework and an application metadata and invokes an application handler to generate device specific data formats.

### CROSS-REFERENCE TO RELATED APPLICATION

The present application claims the priority of the Indian Provisional Patent of Application with serial number 1095/CHE/2011 which is on 31 Mar. 2011 with the title “Cross-Platform Interactive Content Development Platform”, and the PCT application with serial number PCT/IN 2012/000224 filed on Mar. 30, 2012 with the title, “System and Method for Creating and Delivering Platform Independent Interactive Applications on User Devices” and the contents of both the applications are incorporated by entirety and by reference herein.

### BACKGROUND

1. Technical Field

The embodiments herein generally relates to interactive content and interactive applications development, and particularly to a framework for development of cross-platform interactive content and applications. The embodiments more particularly relates to a system and method for development of content suitable for execution on multiple platforms or media running on different software, middleware and operating system.

2. Description of the Related Art

Most internet users today access information and applications on multiple devices such as personal computers (PC), mobile phones, Televisions (TV) etc. Applications on devices such as mobile phones can be either native applications or browser based applications. A native application is designed to run in to computing environment (machine language and OS) being referenced and perform advanced tasks such as telephony and GPS, unlike generic browser based applications. Native applications are usually developed for a specific device such as a set top box or a mobile phone. However, to develop applications that can run across multiple platforms, for example different kinds of set top boxes or mobile phones or home gateways which has ability to interface with native device features is complex.

A particular native application typically may be interpreted only on one type of device and only on one operating platform provided in that device, for example a mobile phone with an android operating system. Though generic browser based applications can run across devices, they have limited functionality as these applications fail to interface with native device interfaces referred to hereafter as native device APIs.

Generally the client devices having different operating platforms and user interfaces may request one or more applications. Depending on the type of device and the platform, for example, a mobile device having svmbian, windows CE, or Embedded Linux operating platform, the application has to be customized by developing it from scratch based on the platform requirements and/or constraints. However, such an approach is quite expensive in terms of development and deployment due to the amount of skilled resources required. Further, additional time is required to reach the market if customized applications and content have to be developed and deployed for each platform and device.

In view of the foregoing, there exists a need for representing content and applications that are interactions on content which can be interpreted and rendered on multiple device platforms. Further such content and applications should be able to interface with native device APIs.

The above mentioned requirements, shortcomings, disadvantages and problems are addressed herein and which will be understood by reading and studying the following specification.

### SUMMARY

The primary object of the embodiments herein is to provide a system and method for generating and delivering platform independent interactive applications and interactive content for a plurality of user devices.

Another object of the embodiments herein is to provide a framework for developing platform independent interactive applications and content for a plurality of user devices.

Yet another object of the embodiments herein is to provide a framework for developing interactive applications and content adaptable for interfacing with the native device APIs on the user device.

Yet another object of the embodiments herein is to provide a framework for developing interactive applications and content adaptable for execution and rendering on multiple user device platforms.

Yet another object of the embodiments herein herein is to reduce the time consumed in developing a device specific applications and content for a plurality of user devices.

Yet another object of the embodiments herein is to provide an application development framework for developing, customized applications which can be deployed for multiple user devices.

These and other objectives and advantages of the present disclosure will become readily apparent from the following detailed description taken in conjunction with the accompanying drawings.

The various embodiments herein provide a system for generating and delivering a platform independent interactive applications and content fir a plurality of user devices. The system comprises an application development framework to generate a plurality of platform independent data formats, a content generating server to generate a plurality of device specific data formats, a content distribution server to create a schedule for delivering the plurality of device specific data formats to the plurality of user devices and a device specific application container to render the application on the user device based on the device specific data format received from the content distribution server. The content generating server includes a data format builder module which takes input from the application's platform independent data format and its application metadata and invokes a device specific application handler module to generate the plurality of device specific data formats.

According to an embodiment herein, the input of the application's platform independent data format is in any of an Extensible Markup Language (XML) format, a Hypertext Markup Language format (HTML), a C data structure, a data structure of any programming language.

According to an embodiment of the present disclosure, the plurality of user devices comprises at least one of a mobile communication device, a set top box and a hybrid media device.

According to an embodiment of the present disclosure, the device specific data format is in at least one of an Extensible Markup Language (XML) format, Hypertext Markup Language (HTML) format, a C data structure and a data structure implemented in any programming language.

According to an embodiment of the present disclosure, the application development framework provides a user interface for developing the application that is a combination of user interface elements, actions allowed on them and content in the form of images, audio and video. The user interface comprises a content builder area which enables a user to create the application by assembling user interface elements and specifying actions allowed on them, a component tool to enable the user to choose from a set of user interface design elements, a properties tool to allow the user to adjust properties of a project designed such as a positional co-ordinates, a width, a height, a background color and a background image for the plurality of data formats corresponding to device specific application elements, a project tool to allow the user to open, save or reset one or more projects as required, a device mode tool to allow the user to select, a device resolution or a device display for the application, a templates tool to enables the user to choose required templates for the application and a workspace tool to specify and place the plurality of application elements for the application. The application development framework generates platform independent data formats corresponding to the application's elements when the project tool is used to save the project.

According to an embodiment of the present disclosure, the content distribution server delivers the plurality of device specific data formats to the plurality of user devices based on at least one of a request from the user device or a predefined data format delivery scheduled for the user device.

According to an embodiment of the present disclosure, the plurality of user devices include a device specific application program interface (API) adapted to subscribe to the content distribution server which requests and obtains the plurality of device specific data formats from the content distribution server and store and cache the plurality of data formats received from the content distribution server on the corresponding plurality of user devices.

According to an embodiment of the present disclosure, the system for generating and delivering a platform independent application for a plurality of user devices further comprises a means for interpreting a data format representing the content such as but not limited to a text, an image and a graphical user interface element for the application, a means for interpreting a plurality of events occurring on or allowed to occur on a plurality of user interface elements described in the data format delivered to the user device, a means for interpreting a plurality of responses from a plurality of components of the application adapted to provide an appropriate change to the plurality of user interface elements in the application of the user device, a means for interpreting a placement of the content in the application, a means for interpreting a plurality of actions such as but not limited to a clicking, a swiping, a tapping and a variety of platform defined gestures on the user device, a means for interpreting a plurality of responses such as but not limited to an image and a data used to describe a part of the application from a plurality of components of the content distribution server or native device APIs.

According to an embodiment of the present disclosure, the placement interpreter comprises a means to determine a height, a width, a spacing, an opacity, and a placement of the plurality of user interface elements on a display of the user device

According to an embodiment of the present disclosure, the means for interpreting a plurality of responses from a plurality of components of the content distribution server or native device APIs comprises at least one means for requesting a data from the user device.

According to an embodiment of the present disclosure, the device specific application container interfaces the plurality of applications to a plurality of native components of the user device. The plurality of native components comprises a means to determine a user's location, a means to determine an acceleration of the user device at a point, a means to play a video or an audio content on the user device, a means to communicate or capture a video and an audio content, a means for storing a plurality of contacts, a means for providing messaging facility, a means for enquiring status on the user device.

According to an embodiment of the present disclosure, the device specific application container comprises at least one means for deploying the application on a plurality of user devices, requesting information from the plurality of user devices using native device APIs, subscribing to changes in the user device, responding to a plurality of requests from a plurality of user devices, integrating the plurality of applications with a service operator such as but not limited to a television operator, a mobile communication operator or a hybrid media network operator for provisioning and billing of content and applications.

According to an embodiment of the present disclosure, the device specific application container further comprises a device specific renderer to parse a device specific data format in the application, a device specific event handler to process a plurality of device specific synchronous and asynchronous events and a plurality of requests generated by the application and a device specific native command handler to enable the plurality of applications to interface with the plurality of device application programming interfaces (APIs) on the user device. The device specific renderer renders a plurality of device specific user interface elements on the user device based on the data format, fetches an application data from the content distribution server and renders relevant components of the application on the user device.

According to an embodiment of the present disclosure, the device specific native command handler further integrates the plurality of applications with any third party applications, social networking portals, search engines or any mapping services.

The embodiments herein further provide a method for generating and delivering a platform independent interactive application and content to a plurality of user devices such as but not limited to a mobile communication device, a TV set top box and a hybrid media device. The method comprises steps of generating a plurality of platform independent data formats representing the platform independent interactive applications, requesting the plurality of platform independent data formats representing interactive content and actions allowed on the application, obtaining the plurality of data formats and the content and a metadata associated with the application, interfacing the plurality of user devices with a content generation server, generating a plurality of device specific data formats, packaging the plurality of device specific data formats and the content with a device specific application container into an application package, sending the application package to a content distribution server, scheduling a delivery of the application package to the user device and delivering the application package to the user device based on a request from the user device or a pre-defined delivery scheduled for the user device. The application is rendered on the user device by the device specific application container based on the device specific data formats received from the content distribution server.

According to an embodiment of the present disclosure, the method for creating and delivering platform independent interactive applications to a plurality of user devices further comprises steps of generating a device specific application logic, a plurality of user interface elements and associated application metadata, installing the application on the user device, rendering the plurality of user interface elements for the application on the user device, executing the application logic on the user device, interfacing the plurality of applications to a plurality of native features of the user device and invoking one or more operator classes for provisioning and billing of the content and applications.

According to an embodiment of the present disclosure, the plurality of native device features on a TV set top box allows a user to perform activities such as a media control, a service selection, a graphics rendition, tuning, to a particular service, finding a location of a set top box, rendering graphics, rendering audio or video, finding out remote control events generated by a TV viewer and deriving program information associated with each of the services broadcasted on the TV platform.

According to an embodiment of the present disclosure, the native device features on a mobile communication device allows a user to perform activities such as acquiring locations, playing media, messaging, using contacts, finding acceleration and various sensing applications on a mobile device.

According to an embodiment of the present disclosure, the native device features on the hybrid media device allows the user to personalize display, request for more content and information from a server, acquire location, interpersonal and social media messaging, a media control, a service selection, a graphics rendering, tuning to a particular service, finding a location of the hybrid media device, rendering graphics, playing audio or video, finding out remote control events generated by the user and deriving program information associated with each of the services broadcasted on the hybrid media platform.

According to an embodiment of the present disclosure, the plurality of device specific data formats are delivered to the user devices by push or pull activity from or to the user devices.

According to an embodiment of the present disclosure, a pull activity from a user device includes requests to the content distribution server where an interactive application is hosted, requests to a TV or a Mobile application store, and requests to a TV or Mobile operator.

According to an embodiment of the present disclosure, a push activity to a user device includes streaming broadcast content that is multiplexed with interactive applications generated by the application development framework, and a mobile push notification that delivers the interactive applications.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating a system for generating and delivering a platform independent application for a plurality of user devices, according to an embodiment of the present disclosure.

FIG. 2 is a block diagram illustrating components of the content generating server, according to an embodiment of the present disclosure.

FIG. 3 is a block diagram illustrating components of the application container, according to an embodiment of the present disclosure.

FIG. 4 is a schematic representation of the user interface of an application development framework, according to an embodiment of the present disclosure.

FIG. 5 is a flow chart illustrating a method for generating and delivering a platform independent application to a plurality of user devices, according to an embodiment of the present disclosure.

Although the specific features of the present disclosure are shown in some drawings and not in others. This is done for convenience only as each feature may be combined with any or all of the other features in accordance with the present disclosure.

### DETAILED DESCRIPTION OF THE DRAWINGS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a common framework for representing content and interactions on content associated with an application that can be interpreted and rendered on one or more class of user devices such as television set top boxes, mobile communication devices such as cell phone, PDAs, and hybrid media devices such as media players and IP set top boxes. The applications developed using the framework can interface with native device APIs. Further representation of the content and interactions on the content associated with the applications can be interpreted and rendered on multiple user device platforms.

The stem for creating and delivering platform independent interactive applications for a plurality of user devices comprises an application development framework to generate a plurality of platform independent data formats, a content generating server to generate a plurality of device specific data formats, a content distribution server to create a schedule for delivering the plurality of device specific data formats to the plurality of user devices and a device specific application container to render the application on the user device based on the plurality of device specific data formats received from the content distribution server. The content generating server includes a data format builder module which takes input from the application and an application metadata and invokes a device specific application handler module to generate the plurality of device specific data formats.

Here the input is in any of an Extensible Markup Language (XML) format, a Hypertext Markup Language format (HTML), a C data structure, a data structure of any programming language and the plurality of user devices comprises at least one of a mobile communication device, a set top box and a hybrid media device.

The device specific data format is in at least one of an Extensible Markup Language (XML) format, Hypertext Markup Language (HTML) format, a C data structure and a data structure implemented in any programming language.

The application development framework includes a user interface which provides various parameters for de eloping the platform independent application. The user interface comprises a content builder area which enables a user to create an application from a plurality of device specific application elements, a component tool to enable the user to choose from a set of user interface design elements, a properties tool to allow the user to adjust properties of a project designed such as a positional co-ordinates, a width, a height, a background color and a background image for the plurality of data formats corresponding to device specific application elements, a project tool to allow the user to open, save or reset one or more projects as required, a device mode tool to allow the user to select a device resolution or a device display for the application, a template tool to enables the user to choose required templates for the application and a workspace tool to specify and place the plurality of application elements fir the application. An application's platform independent device formats associated with its user interface elements and actions allowed on them are generated when the application development framework's project tool is used to save the application development project.

The content distribution server delivers the plurality of device specific data formats to the plurality of user devices based on at least one of a request from the user device or a predefined data format delivery scheduled for the user device.

The plurality of user devices include a device specific application program interface (API) adapted to subscribe to the content distribution server, request the plurality of device specific data formats from the content distribution server and store and cache the plurality of data formats received from the content distribution server on the user device.

The system for generating and delivering a platform independent application for a plurality of user devices further comprises a means for interpreting a data format representing the content such as but not limited to a text, an image and a graphical user interface element for the application, a means for interpreting a plurality of events occurring on a plurality of user interface elements described in the data format delivered to the user device, a means for interpreting a plurality of responses from a plurality of components of the application adapted to provide an appropriate change to the plurality of user interface elements in the application of the user device, a means for interpreting a placement of the content in the application, a means for interpreting a plurality of actions such as but not limited to a clicking, a swiping, a tapping and a variety of platform defined gestures on the user device, a means for interpreting a plurality of responses such as but not limited to an image and a data used to describe a part of the application from a plurality of components of the content distribution server or from native device APIs.

The means of interpreting the placement of contents in an application comprises a means to determine a height, a width, a spacing, an opacity, and a placement of the plurality of user interface elements on a display of the user device

The means for interpreting a plurality of responses from a plurality of components of the content distribution server comprises a means for requesting a data from the user device.

The device specific application container interfaces the plurality of applications to a plurality of native components of the user device. The plurality of native components comprises a means to determine a user's location, a means to determine an acceleration of the user device at a point, a means to play a video or an audio content on the user device, a means to communicate or capture a video and an audio content, a means for listing and storing a plurality of contacts, a means for providing messaging facility, a means for enquiring device status on the user device.

The device specific application container comprises at least one means for deploying the application on a plurality of user devices, requesting information from the plurality of user devices, subscribing to changes in the user device, responding to a plurality of requests from the plurality of user devices, integrating the plurality of applications with a service operator such as but not limited to a television operator, a mobile communication operator or a hybrid media network operator for provisioning and billing of the content and the application.

The device specific application container further comprises a device specific renderer to parse a device specific data format in the application, a device specific event handler to process a plurality of device specific synchronous and asynchronous events and a plurality of requests generated by the application and a device specific native command handler to enable the plurality of applications to interface with the plurality of device application programming interfaces (APIs) on the user device. The device specific renderer renders a plurality of device specific user interface elements on the user device based on the data format, fetches an application data from the content distribution server and renders relevant components of the application on the user device.

The device specific native command handler further integrates the plurality of applications with any third party applications, social networking portals, search engines or any mapping services.

The method for generating and delivering a platform independent application to a plurality of user devices such as but not limited to a mobile communication device, a TV set top box and a hybrid media device, comprises steps of generating a plurality of platform independent data formats representing the platform independent application, requesting the plurality of platform independent data formats representing a content and actions allowed on the application's elements, obtaining the plurality of data formats and the content and a metadata associated with the application, interfacing the plurality of user devices with a content generation server, generating a plurality of device specific data formats, packaging the plurality of device specific data formats and the content with a device specific application container into an application package, sending the application package to a content distribution server, scheduling a delivery of the application package to the user device and delivering the application package to the user device based on a request from the user device or a pre-defined delivery time/location scheduled for the user device. The application is rendered on the user device based on the device specific data formats received from the content distribution server.

The method for generating and delivering a platform independent application to a plurality of user devices further comprises steps of generating a device specific application logic, a plurality of user interface elements and associated application metadata, rendering the plurality of user interface elements for the application on the user device, installing the application on the user device, executing the application logic on the user device, interfacing the plurality of applications to a plurality of native features of the user device and invoking one or more service operator classes for provisioning and billing of the content and applications.

The plurality of native. device features on a TV set top box allows a user to perform activities such as a media control, a service selection, a graphics rendition, tuning to a particular service, finding a location of a set top box, rendering graphics, rendering audio or video, finding out remote control events generated by a TV viewer and deriving program information associated with each of the service broadcasted on the TV platform.

The native device features on a mobile communication device allows a user to perform activities such as acquiring locations, playing media, messaging, listing, contacts, finding acceleration and various sensing applications on the mobile communication device.

The native device features on the hybrid media device allows the user to personalize display, request for more content and. information from a server, acquire location, interpersonal and social media messaging, a media control, a service selection, a graphics rendering, tuning to a particular service, finding a location of the hybrid media device, rendering graphics, playing audio or video, finding out remote control events generated by the user and deriving program information associated with each of the service broadcasted on the hybrid media platform.

The plurality of device specific data formats are delivered to the user devices by either a push to the user device or a pull activity from the user device.

The pull activity from the user device includes requests to content distribution server where an interactive application is hosted, requests to a TV or a Mobile application store, and requests to a TV or Mobile operator and the push activity to a user device includes streaming broadcast content that is multiplexed with an interactive application generated by the application development framework, and a mobile push notification that delivers the interactive application.

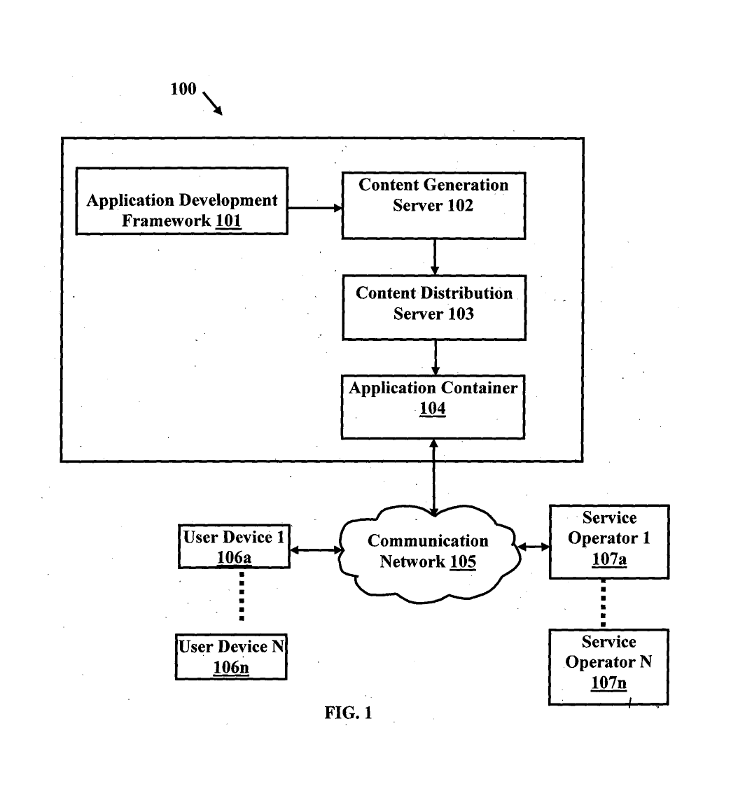

FIG. 1 is a block diagram illustrating a system for generating and delivering a platform independent application for a plurality of user devices, according to an embodiment of the present disclosure. The system 100 comprises an application development framework 101 to generate a plurality of platform independent data formats, a content generating server 102 to generate a plurality of device specific data formats, a content distribution server 103 to create a schedule for delivering the plurality of device specific data formats to the plurality of user devices user device 1 106a to user device N 106n and a device specific application container 104 to render the application on the user device based on the plurality of device specific data formats received from the content distribution server 103. The user devices user device 1, user device 2, . . . user device N 106a-106n is at least one of a mobile communication device, a television set top box, a hybrid media devices such as connected hybrid media players, music players, etc. Each of the user devices includes a plurality of native device APIs or device specific application program interfaces (API). The application container 104 is integrated with a plurality of service operators service operator 1 107a, service operator 2 107b, . . . service operator n 107n. The plurality of service operators 107a-107n is at least one of a television operator, a mobile communication operator or a hybrid media network operator.

The application development framework 101 takes an input from a content and application developer in the form of the application and a metadata in XML format and a plurality of modifiers associated with the application. The content generating server 102 invokes the application metadata universal resource locator (URL) from the application development framework 101. The content generating server 102 processes at least one input by an input means. The input is in any of a Extensible Markup Language (XML) format, a Hypertext Markup Language format (HTML), a C data structure or a data structure of any programming language.

The content generating server 102 generates a plurality of device specific data formats. The content generating server 102 packages the application along with a device specific application container 104 for a user device platform. The content distribution server 103 delivers the plurality of device specific data formats to corresponding user device. The device specific data format is a data format compatible with a data format of the user device. The data format of the user device is at least one of a TV data format, a mobile data format, a hybrid media data format stored m the content distribution server. The device specific data formats are delivered based on at least one of a service subscribed by a user device or a push to the user device.

The content distribution server 103 includes a device specific scheduler for delivering the plurality of device specific data formats to the user devices 106a-106n. The scheduler includes, but not limited to, a TV scheduler that delivers TV data formats to a plurality of televisions, a mobile scheduler that delivers mobile data formats to a plurality of mobile communication devices and a hybrid media scheduler which delivers a hybrid media data formats to a plurality of hybrid media devices.

The device specific application container 104 is an application framework which executes and renders one or more applications on the plurality of user devices 106a-106n based on the plurality of device specific data formats received from the content distribution server 103. The device specific data formats are be delivered by a push activity to the user devices or a pull activity from the user devices 106a-106n.

According to one embodiment, the device specific application container 104 renders the applications on a television set top box broadcasted over the air by the push activity. The broadcasting system includes a content encoder, content multiplexer and a content streamer. The content streamer streams the plurality of device specific data formats to the set top box via at least one of a satellite, a cable or a broadband link, etc.

In one embodiment, a push activity in mobile communication device occurs as a notification. The notification is delivered, on the mobile communication device by the content distribution server 103. The plurality of device specific data formats interface with a plurality of device specific application programming interfaces (API's). The device specific application container 104 can also install the application on the mobile communication device.

The plurality of native device features on a TV set top box allows a user to perform activities such as a media control, a service selection, a graphics rendition, tuning to a particular service, finding a location of a set top box, rendering graphics rendering audio or video, finding out remote control events generated by a TV viewer and deriving program information associated with each of the services broadcasted on the TV platform.

The plurality of native device features on a mobile communication device allows a user to perform activities such as acquiring locations, playing media, messaging, listing contacts, finding acceleration and various sensing applications on a mobile device.

The native device features on the hybrid media device allows the user to personalize display, request for more content and information from a server, acquire location, interpersonal and social media messaging, a media control, a service selection, a graphics rendition, tuning to a particular service, finding a location of the hybrid media device, rendering graphics, rendering audio or video, finding out remote control events generated by the user and deriving program information associated with each of the services broadcasted on the hybrid media platform

The application deployed by the content distribution server 103 interfaces with the plurality of native device APIs. The device specific application container 103 handles a user interface and an application's logic specified in any one of the formats such as but not limited to XML, HTML, CSS, JavaScript or data structures implemented in any other programming language. Event specific actions such as time dependent rendering of applications (e.g., advertisements) on the user devices 106a-106n can be enforced. The device specific application container 104 renders the application's user interface, executes application's logic and interfaces with the plurality of native device platform features on the corresponding devices.

The user device have mechanisms for instantaneously constructing a plurality of applications on multiple TV, mobile and connected hybrid media devices from a plurality of data formats. In one embodiment, the user devices have mechanisms for interpreting the placement of content in the applications. The content includes user interface elements that are specific to a TV application for a TV platform, a mobile application for a mobile platform, and a hybrid media application for a hybrid media device platform. The content in the applications includes text, images and graphical user interface elements on which users can perform activities on the TV application, the mobile application and/or hybrid media application.

Further, the user devices includes a means for interpreting events occurring on the user interface elements, a means for interpreting responses from one or more components of the application from the content generating server or from native device APIs and make appropriate changes to the user interface elements in the application, a means for interpreting a placement of content comprising ways to determine a height, a width, a spacing, an opacity, a placement of user interface elements on a display output of the user device and a means for interpreting actions allowed on the user interface elements. The actions may include but is not limited to a clicking, a swiping, a tapping and a variety of platform defined gestures on the user device.

The user device further includes a means for interpreting responses from one or more components of the content distribution server 103. The responses from one or more components include was of requesting data from the user device. The responses include one of an image or a data used to describe a part of the application. The part of the application is constructed upon receipt of the response from one or more components of the content distribution server 103.

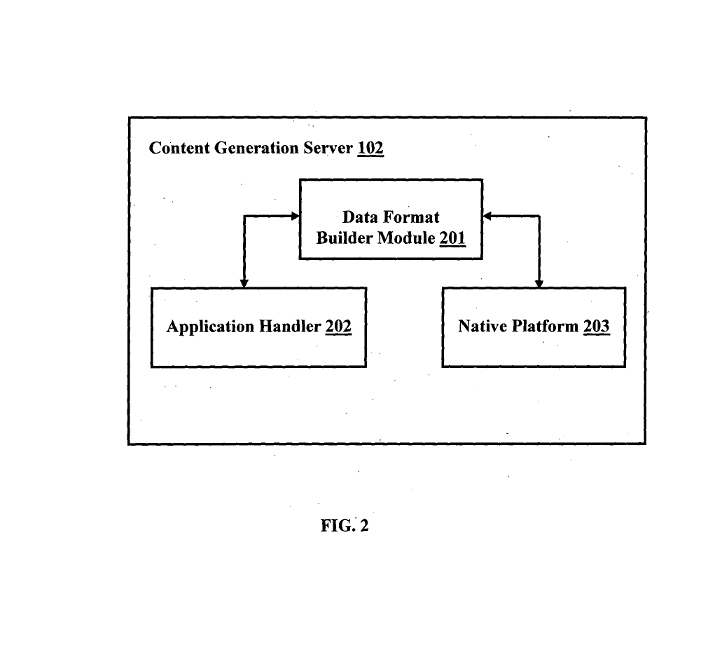

FIG. 2 is a block diagram illustrating components of the content generating server, according to an embodiment of the present disclosure. The content generating server 102 includes a data format builder module 201. The data format builder module 201 takes input in the form of platform independent data formats from the application development framework and an application metadata and invokes a device specific application handler module 202 to generate the plurality of device specific data formats. The input is in any of an Extensible Markup Language (XML) format, a Hypertext Markup Language format (HTML), a C data structure or a data structure of any programming language

For example, the content builder module specific to television invokes the application handler module of the television. The content builder module specific to TV generates a plurality of data formats that are specific to TV platform, an application logic specific to TV, a user interface specific to TV and associated metadata. Similarly, the content builder module specific to mobile communication device invokes the application handler module of the mobile communication device. The content builder module specific to mobile communication device generates a plurality of data formats that are specific to a mobile communication device platform, an application logic specific to a mobile communication device, a user interface specific to a mobile communication device and associated metadata. Similarly, the content builder module specific to hybrid media device invokes the application handler module of the hybrid media device. The content builder module specific to hybrid media device generates a plurality of data formats that are specific to a hybrid media device, application logic specific to a hybrid media device, a user interface specific to a hybrid media device and associated metadata.

The device specific application handler module 202 resides on the content generating server 102. The device specific data formats are delivered to the user device based on either a request from the user device or based on a schedule of delivery to the user device. The plurality of user devices 106a-106n connected to the content distribution server 103 have mechanisms to subscribe to or request data formats from the content distribution server 103. The plurality of user devices 106a-106n also have mechanisms to store and cache the data formats received from the content distribution server 103.

The device specific application container 104 of FIG. 1 enables rendering of the application user interface, execution of the application logic and interfacing with the plurality of native device platform features. The device specific application container 104 invokes service operator classes for provisioning and billing of the content and applications.

The users can assign properties to applications that the device specific application container 104 can enforce before and during application execution on the user devices 106a-106n. For mobile communication devices, such properties may include directives to charge application users before or during use of the application or a number of installations permitted per charge. For set top boxes, such properties may indicate conditional access directives on whether the device specific application container 104 can render content or execute the application. Such properties are provided in the form of separate configuration files or the metadata associated in the application package that the device specific application container 104 evaluates at the initiation of the application lifecycle. The device specific application container 104 enforces such properties provided either by validating against configuration files or by interfacing, with the plurality of service operators 107a-107n for provisioning and billing interfaces.

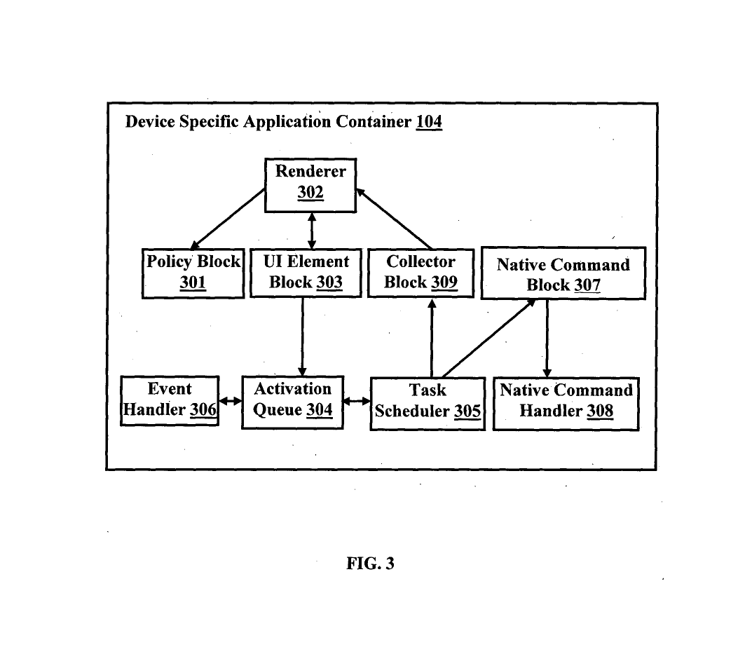

FIG. 3 is a block diagram illustrating the components of the application container. The device specific application container 104 comprises a policy block 301, a device specific renderer 302, a user interface (UI) element block 303, an activation queue 304, a task scheduler 305, an event handler 306, a native command block 307, a device specific native command handler 308 and a collector block 309.

The policy block 301 stores policies of a service operator corresponding to the user device for the content and the application's use. The policies are related to billing and provisioning systems of the service operator. The policy is at least one of a provisioning policy, a billing policy, conditional access policy. The provisioning systems indicate usage of the application by a user. The usage of the application is such as but not limited to a number of times a user can install/run the application without repaying for the application. The billing system generates a bill for the service provided to the user based on the usage.

The device specific renderer 302 parses a device specific data format in the application. The device, specific renderer 302 renders a plurality of device specific user interface elements on the user device based on the data format, fetches the application from the content distribution server, parses the metadata associated with the application and renders relevant components of the application on the corresponding user device.

The user interface (UI) element block 303 a plurality of elements. Each element has the ability to render a specific type of user interface such as but not limited to a button or a scroll bar.

The activation queue 304 stores actions such as but not limited to events and actions taken by the application's user. The actions pertain to specific events triggered on certain user interface elements. For example, a button click may qualify as an event that can trigger an action such as fetching a location, of a mobile communication device.

The task scheduler 305 stores and schedules tasks. The task scheduler is useful in single threaded application environments such as a set to box. The task scheduler may also invoke a time and a specific platform generated event.

The event handler 306 processes a plurality of device specific synchronous events and asynchronous events and a plurality of requests generated by the application. The event handler is invoked when an event occurs. For example, a button click may be classified as a synchronous event if it leads to an immediate change in the state of the application such as a need to display another page of the application. In contrast, invoking a GPS on a mobile communication device to acquire location information may be classified as an asynchronous event since the duration after which the location data is available is not definite.

The native command block 307 has one or more methods for interfacing the applications with the plurality of native platform features such as media and service control functions on the set top boxes, contact managers, telephony and GPS on the mobile communication device. The methods are implemented in a programming language compatible to the user device platform and also provide one or more interfaces for communicating with the application.

The device specific native command handler 308 enables the application to interface with the plurality of device application programming, interfaces (APIs) on the user device. The device specific native command handler further integrates the application with any third party applications, social networking portals, search engines or any mapping services.

The collector block 309 collects one or more results from asynchronous actions such as native platform invocations. After collecting the results, the collector block notifies the renderer. The renderer uses the acquired data for rendering the results.

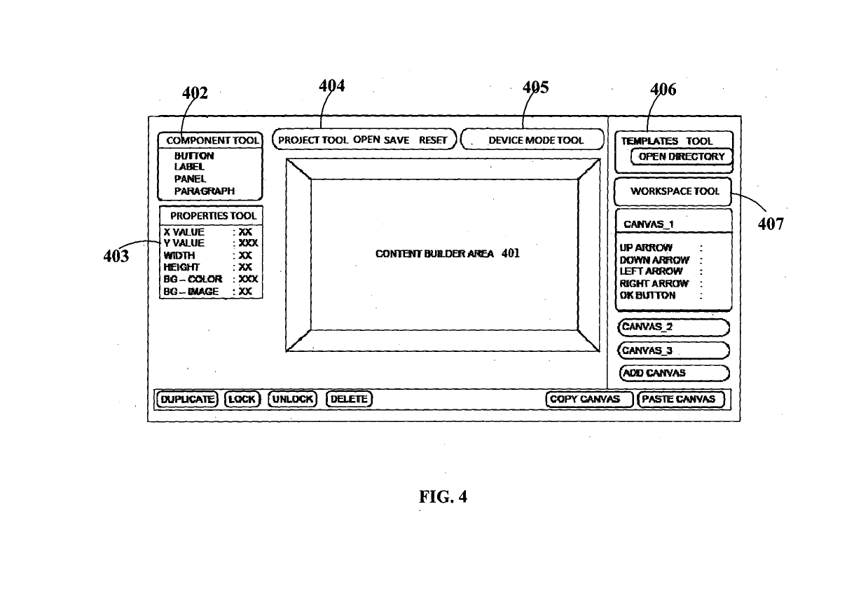

FIG. 4 is a schematic representation of the user interface of an application development framework, according to an embodiment of the present disclosure. The user logs into the content generating server 102 by providing the login credentials. On logging in and selecting the option from the menu, the user interface of the application development framework 101 is displayed. The user interface includes a content builder area 401, a component tool 402, a properties tool 403, a project tool 404, a device mode tool 405, a templates tool 406 and a workspace tool 407. The content builder area 401 is the work area for the developer to create an assembly of user interface elements that corresponds to a device specific application.

The component tool 402 enables the developer to choose from a set of designing elements. The properties tool 403 allows the developer to adjust properties of a project designed. In one embodiment, the properties tool 306 enables the developer to adjust positional co-ordinates, a width, a height, a background color and a background image for the plurality of data formats corresponding to the device specific application.

The project tool 308 allows the user to open, save or reset a plurality of projects as per requirement and saving a project generates an application's platform independent data format. The device mode tool 405 allows the user to adjust a device resolution or a device display for the application. The templates tool 406 enables the user to choose required templates for the application design. The workspace tool 407 specifies the project on which the plurality of platform independent data formats for a plurality of applications is generated. The application development framework allows the developer to generate data formats that represent a content and interactions on the content associated with an application on the content builder area 401 with the help of a plurality of tools on the user interface of the application development framework 101.

The plurality of platform independent data formats developed using, the application development framework 101 is sent to the contenting generating server 102. Based on the plurality of platform independent data formats, the contenting generating server 102 matches the plurality of platform independent data formats with a plurality of device specific data formats stored in a database. Further, based on the received data formats, the content generating server 102 generates the plurality of device specific data formats representing the application.

The device specific application container 104 renders the application based on the plurality of device specific data formats of the application. The plurality of device specific data formats for a set top box includes but is not limited to a platform type, a display color, a display texture, a foreground color, a background color, an image style, properties, actionable elements such as but not limited to buttons, a font size and a style. In addition to a platform type, a display color, a display texture, a foreground color, a background color, an image style, properties, actionable elements such as buttons, a font size and a style, the plurality of device specific data formats for a mobile communication device includes scheduling details such as time slots. Based on the time slots, appropriate notifications are delivered to user mobile communication device.

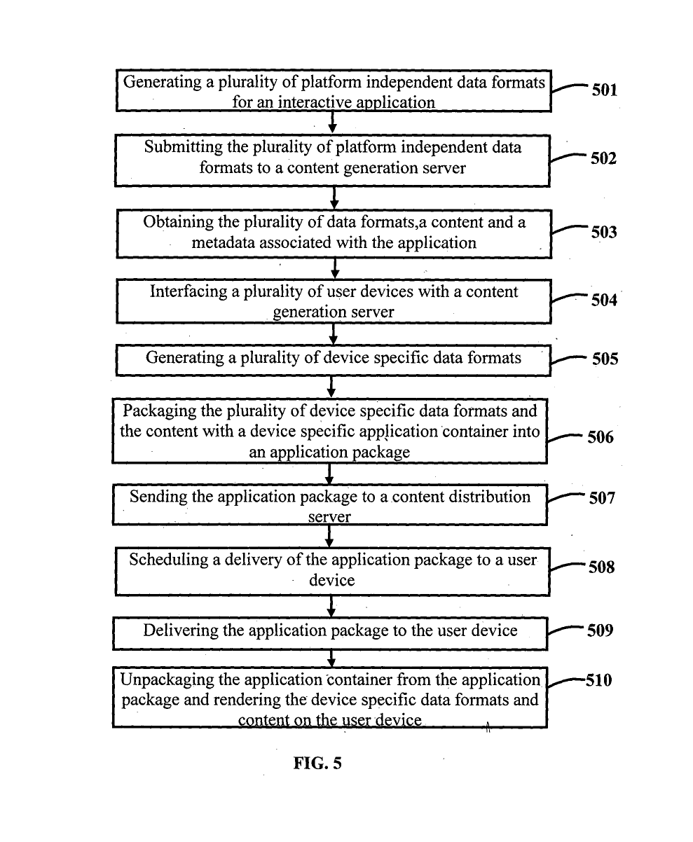

FIG. 5 is a flow chart illustrating a method for generating and delivering a platform independent application to a plurality of user devices, according to an embodiment of the present disclosure. The method comprises steps of generating a plurality of platform independent data formats representing the application 501, requesting the plurality of platform independent data formats representing a content and actions on content associated with the application 502, obtaining the plurality of data formats and content and a metadata for the application 503, interfacing, the plurality of user devices with a content generation server 504, generating, a plurality of device specific data formats 505, packaging the plurality of device specific data formats and content with a device specific application container into an application package 506, sending, the application package to a content distribution server 507, scheduling a delivery of the application package to the plurality of user devices 508, delivering the application package to at least one of the plurality of user devices 509 and executing the application container from the application package on the user device 510. The application package is delivered to the user device based on at least one of a request from the user device or based on a pre-defined delivery scheduled for the user device. The application is rendered on the user device by the application container based on the plurality of device specific data formats received from the content distribution server. The plurality of device specific data formats are delivered to the user device by a push or pull activity from or to the user devices.

The plurality of user devices comprises a mobile communication device, a TV set top box and a hybrid media device.

The method for generating and delivering a platform independent application to a plurality of user devices further comprises steps of generating a device specific application logic, a plurality of user interface elements and associated application metadata, installing the application on the user device, rendering the plurality of use interface elements for the application on the user device, executing the application logic on the user device, interfacing the plurality of applications to a plurality of native features of the user device and invoking one or more service operator classes for provisioning and billing of the content and applications.

The plurality of native device features on a TV set top box allows a user to perform activities such as a media control, a service selection, a graphics rendition, tuning to a particular service, finding a location of a set top box, rendering graphics, rendering audio or video, finding out remote control events generated by a TV viewer and deriving program information associated with each of the services broadcasted on the TV platform.

The native device features on a mobile communication device allows a user to perform activities such as acquiring locations, playing media, messaging, enabling contacts, messaging and telephony, finding acceleration and various sensing applications on a mobile device.

The native device features on the hybrid media device allows the user to personalize display, request for more content and information from a server, acquire location, interpersonal and social media messaging, a media control, a service selection, a graphics rendition, tuning to a particular service, finding a location of the hybrid media device, rendering graphics, rendering audio or video, finding out remote control events generated by the user and deriving program information associated with each of the services broadcasted on the hybrid media platform.

The embodiments herein can take the form of an entirely software embodiment or an embodiment including both hardware and software elements. The embodiments that are implemented in software include but are not limited to firmware, resident software, microcode, etc. Furthermore, the embodiments herein can take the form of at computer program product accessible from a computer-usable or computer-readable medium providing program code for use or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The embodiments herein provide a system and method for developing and delivering platform independent applications for a plurality of user devices. The embodiments herein provide a framework for developing platform independent applications for a plurality of user devices. Further the embodiments herein provide a framework for developing applications able to interface with the native applications on the user device.

The embodiments herein provide a suitable way for reducing the time consumed in developing a device specific application and content for a plurality of user devices. The productivity of application and content development for a plurality of user devices can be increased using the system and method described herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for creating and delivering a platform independent application for a plurality of user devices, the system comprises:
an application development framework to generate a plurality of platform independent data formats;
a content generating server to generate a plurality of device specific data formats;
a content distribution server to create a schedule for delivering the plurality of device specific data formats to the plurality of user devices; and
a device specific application container to render the application on the user device based on the plurality of device specific data formats received from the content distribution server;
wherein the content generating server includes a data format builder module which takes input from the application, application's platform independent data format and an application metadata and invokes a device specific application handler module to generate the plurality of device specific data formats where the input of the application's platform independent data format is in any of an Extensible Markup Language (XML) format, a Hypertext Markup Language format (HTML), a C data structure or a data structure of any programming language.

2. The system of claim 1, wherein the plurality of user devices comprises at least one of a mobile communication device, a set top box and a hybrid media device.

3. The system of claim 1, wherein the plurality of device specific data formats is in at least one of an Extensible Markup Language (XML) format, Hypertext Markup Language (HTML) format, a C data structure and a data structure implemented in an programming language.

4. The system of claim 1, wherein the application development framework provides an user interface for developing the application, wherein the user interface comprises:
a content builder area which enables a user to create applications by assembling user interface elements and specifying actions allowed on the applications;
a component tool to enable the user to choose from a set of user interface design elements;
a properties tool to allow the user to adjust properties of a project designed, where the properties include a positional co-ordinates, a width, a height, a background color and a background image for the plurality of platform independent data formats corresponding to the plurality of device specific application elements;
a project tool to allow the user to open, save or reset one or more applications as required;
a device mode tool to allow the user to select a device resolution or a device display for the application;
a template tool to enable the user to choose required templates for the application; and
a workspace tool to specify and place the plurality of device specific application elements for the application;
wherein the application development framework generates platform independent data formats corresponding to the application's elements when a project tool is used to save an application.

5. The system of wherein the content distribution server delivers the plurality of device specific data formats to the plurality of user devices based on at least one of a request from the user device or a predefined data format delivery scheduled for the user device.

6. The system of claim 1, wherein the plurality of user devices includes a device specific application program interface (API) adapted to:
subscribe to the content distribution server;
request and obtain one or more device specific data formats from the content distribution server; and
store and cache the one or more device specific data formats received from the content distribution server on the corresponding plurality of user devices.

7. The system of claim 1, further comprises a means for:
interpreting a data format representing the content for the application, wherein the content comprises a text, an image and a graphical ᵤser interface element;
interpreting a plurality of events occurring, on a plurality of user interface elements described in the data format delivered to the user device;
interpreting a plurality of responses from a plurality of components of the application, wherein the means for interpreting the plurality of responses from the plurality of components of the application is adapted to customize the plurality of user interface elements in the device specific application;
interpreting a placement of the content in the application, wherein the interpreting means comprises a means to determine a height, a width, a spacing, an opacity, and a placement of the plurality of user interface elements on a display of the user device;
interpreting a plurality of actions allowed on the plurality of user interface elements, wherein the plurality of actions comprises a clicking, a swiping, a tapping and a variety of platform defined gestures on the user device; and
interpreting a plurality of responses from a plurality of components of the content distribution server, wherein the plurality of responses comprises one of a image and a data used to describe a part of the application constructed based on the plurality of responses.

8. The system of claim 1, wherein the device specific application container interfaces the plurality of applications to a plurality of native components of the user device, wherein the plurality of native components comprises a means to determine a user's location, a means to determine an acceleration of the user device at a point, a means to play a video or an audio content on the user device, a means to communicate or capture a video and an audio content, a means for accessing and storing a plurality of contacts, a means for providing messaging facility and a means for enquiring device status on the user device.

9. The system of claim 1, wherein the device specific application container comprises at least one means for:
deploying the application on the plurality of user devices;
requesting information from the plurality of user devices using native device APIs;
subscribing to changes in at least one of a plurality of user device;
responding to a plurality of requests from the plurality of user devices;
integrating the plurality of applications with a service operator and provisioning and billing of the content and the applications, wherein the service operator is at least one of a television operator, a mobile communication operator or a hybrid media network operator.

10. The system of claim 1, wherein the device specific application container further comprises of:
a device specific renderer to parse the plurality of device specific data formats in the application, wherein the device specific renderer renders a plurality of device specific user interface elements on the user device based on the data format, fetches a application data from the content distribution server and renders relevant components of the application;
a device specific event handler to process a plurality of device specific synchronous events and asynchronous events and a plurality of requests generated by the application; and
a device specific native command handler to enable the plurality of applications to interface with the plurality of device application programming interfaces (APIs) on the user device, wherein the device specific native command handler further integrates the plurality of applications with any third party applications, social networking portals, search engines or any mapping services.

11. A method for generating and delivering a platform independent application to a plurality of user devices comprising steps of:
generating a plurality of platform independent data formats representing the platform independent application;
requesting for the plurality of platform independent data formats representing a content and action on content associated with the application;
obtaining the plurality of data formats, content and a metadata for the application;
interfacing the plurality of user devices with a content generation server;
generating a plurality of device specific data formats;
packaging the plurality of device specific data formats and the content with a device specific application container into an application package;
sending the application package to a content distribution server;
scheduling a delivery of the application package to the plurality of user devices; and
delivering the application package to at least one of the plurality of user devices;
wherein the application package is delivered to the user device based on at least one of a request from the user device or based on a pre-defined delivery scheduled for the user device.

12. The method of claim 11, wherein the application is rendered on the user device based on device specific data formats received from the content distribution server.

13. The method of claim 11, wherein the plurality of user devices comprises a mobile communication device, a TV set top box and a hybrid media device.

14. The method of claim 11, further comprising steps of:
generating a device specific application logic, a plurality of user interface elements and associated application metadata;
installing the application on the user device;
rendering the plurality of user interface elements for the application on the user device;
executing the application logic on the user device;
interfacing the plurality of applications to a plurality of native features of the user device, and
invoking one or more service operator classes for provisioning and billing of the content and applications.

15. The method of claim 14, wherein the plurality of native device features on a TV set top box allows a user to perform activities such as a media control, a service selection, a graphics rendition, tuning to a particular service, finding a location of a set top box, rendering, graphics, rendering audio or video, finding out remote control events generated by a TV viewer and deriving program information associated with each of the services broadcasted on the TV platform.

16. The method of claim 14, wherein the native device features on a mobile communication device allows a user to perform activities such as acquiring locations, playing media, messaging, accessing contacts, finding acceleration and various sensing applications on the mobile communication device.

17. The method of claim 14, wherein the native device features on the hybrid media device allows the user to personalize display, request for content and information from a server, acquire location, interpersonal and social media messaging, a media control, a service selection, a graphics rendition, tuning to a particular service, finding a location of the hybrid media device, rendering graphics, rendering audio or video, finding out remote control events generated by the user and deriving program information associated with each of the services broadcasted on the hybrid media platform.

18. The method of claim 11, wherein the one or more device specific data formats are delivered to the user devices by a push activity or a pull activity from or to the user device.

19. The method of claim 11, wherein the pull activity from the user device includes request to the content distribution server where the interactive application is hosted, requests to a TV or a Mobile application store, and requests to a TV or Mobile operator.

20. The method of claim 11, wherein the push activity to the user device includes streaming broadcast content which is multiplexed with the interactive application generated by the application development framework and a mobile push notification that delivers the interactive application to the user device.
